(19) United States
(12) Patent Application Publication
(10) Pub. No.: US 2008/0092737 A1
(43) Pub. Date: Apr. 24, 2008

(54) APPARATUS FOR THE PREVENTION OF METAL TARNISH

(76) Inventors: Scott Storbo, Miami Beach, FL (US); Scott Gray, Miami Beach, FL (US)

Correspondence Address: DAVIS WRIGHT TREMAINE LLP/Los Angeles, 865 FIGUEROA STREET, SUITE 2400, LOS ANGELES, CA, 90017-2566, US

(21) Appl. No.: 11/550,679

(22) Filed: Oct. 18, 2006

(51) Int. Cl. B01D 53/02; B01D 59/26

(52) U.S. Cl. 95/90; 96/108; 96/134; 96/151; 96/154

(57) ABSTRACT

A filter, an apparatus and a method for preventing and/or reducing the formation of tarnish on objects that contain a metal are provided; for example, objects containing silver, copper and/or brass. The apparatus comprises a device that circulates the air in an enclosed space through particulate and adsorbent filters to reduce the amount of tarnishing agents present in said enclosure.

### FIELD OF INVENTION

The present invention relates to a filter, an apparatus and a method for preventing or reducing the formation of tarnish on objects comprising a metal; for example, objects containing silver, copper, or brass.

### BACKGROUND OF THE INVENTION

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Tarnish is a term which describes the visual change in the lustrous surface of a metal after it has reacted with various atmospheric components. Most frequently, tarnish is associated with the discolorization of objects made of silver; silver alloys, in which silver is the predominant component; copper; or brass, which is an alloy of copper and zinc. The chemical process which causes tarnish is the corrosion of the metal surface through an oxidative process. However, the primary route of oxidation, in many instances, can be caused by materials other than oxygen. It is well known that silver and silver alloys tend to tarnish in the gaseous atmospheres containing hydrogen sulfide or other sulfide compounds, even in small concentrations, particularly in the simultaneous presence of ammonia, resulting in a dull or black finish. Copper reacts with hydrogen sulfide in a similar fashion as silver because both elements have the same outermost electron shell configuration according to the Periodic Table. However, copper is more reactive than silver and after the initial tarnishing by hydrogen sulfide to produce a red or dark brown surface, it can further react with carbon dioxide in the atmosphere to produce a green patina which has been associated with older copper structures such as the Statue of Liberty. The reaction of tarnishing agents on objects comprising silver, copper, or combinations thereof may be accelerated in the presence of water vapor.

The sources and concentrations of hydrogen sulfide in the atmosphere and indoor air are varied. Man-made sources of hydrogen sulfide include industrial emissions from the burning of fossil fuels, natural gas, chemical plants, poorly ventilated sewage lines, sewage treatment facilities, and farms. Natural sources include geothermal emissions, anaerobic bacterial processes, and salt water bodies. In the indoor environment, gaseous by-products from human digestive processes are a major source. It is, therefore, difficult to place a value on what might be considered an average or typical range for hydrogen sulfide concentrations in the atmosphere or indoor environment. The U.S. Environmental Protection Agency (“USEPA”) has estimated that the average concentration for hydrogen sulfide in the atmosphere is 0.1 to 0.3 parts per billion (“ppb”) (see USEPA report number EPA/600/8-86/026F, Health Assessment Document for Hydrogen Sulfide, January 1993). It should be clearly noted that this is an average concentration and peak levels may be higher by several hundred fold as is evident in the USEPA report.

The control of hydrogen sulfide also has long been a concern in the area of prevention of corrosion of silver and copper electronic contacts in sensitive electronic equipment. The tarnishing and corrosion of silver and copper contacts can result in the premature failure of electronic equipment.

Sulfide films on silver or copper objects can be removed from their surfaces by chemical treatment or polishing. The formation of sulfide films can be prevented by forming on the objects a film of another stable metal, such as rhodium, or of oxide of aluminum, beryllium, technetium, or zirconium. However, all of these methods have disadvantages. Chemical treatment and polishing gradually remove part of the original metal. Accidental scratches in the film of stable metal or oxides expose the fresh silver or copper surface to oxidation by hydrogen sulfide.

Thus, there is a need in the art for a filter, an apparatus and a method to prevent or reduce the formation of tarnish. It is the object of the present invention to provide such filters, apparatuses and methods for preventing or reducing the formation of tarnish on objects comprising silver, copper and combinations thereof.

### SUMMARY OF THE INVENTION

The following embodiments and aspects thereof are described and illustrated in conjunction with apparatuses and methods which are meant to be exemplary and illustrative, not limiting in scope.

The present invention includes filters, apparatuses and methods for the prevention and/or reduction of the formation of tarnish on objects containing metal.

Various embodiments provide for apparatuses for preventing or reducing the formation of tarnish on an object, comprising an adsorbent and a device to circulate air through said adsorbent to remove an agent that causes the formation of tarnish on said object. The device may be a fan. Said adsorbent may be a physisorber, a chemisorber, an ion exchange material, a catalytic agent and combinations thereof. Said physisorber may be activated carbon, activated alumina, silica, silica gel, natural zeolite, synthetic zeolite, a molecular sieve and combinations thereof, and said chemisorber may be potassium permanganate, calcium carbonate, calcium sulfate, sodium carbonate, sodium hydroxide, calcium hydroxide, powdered metal, a reactant capable of scavenging gas phase contaminants and combinations thereof. The apparatus may further comprise a first porous layer, wherein said adsorbent is adhered to or non-adheredly placed next to said first porous layer, whereby an adsorbent filter is created. The apparatus may also further comprise a second porous layer, wherein said adsorbent is configured between said first porous layer and said second porous layer thereby creating an adsorbent filter. In one embodiment, the apparatus may also comprise a removable filter cartridge that encases said adsorbent.

In another embodiment, the apparatus further comprises an intake vent to allow air to flow into said apparatus, a pre-filter to remove a particulate contaminant prior to allowing the air to flow through said adsorbent and an exhaust vent to allow air to flow out of said apparatus.

In another embodiment, said adsorbent filter in the apparatus may further comprise a halide or a metal halide. The metal of said metal halide may be zinc, aluminum, magnesium, calcium, iron and combinations thereof.

In another embodiment, said apparatus further comprises a box that stores said object, wherein said apparatus is integrated into said box.

In another embodiment, said apparatus is adapted for use with a jewelry box, a silverware case, electronic equipment, or a computer.

In another embodiment, said apparatus is adapted for use with an air circulation system.

Other embodiments of the present invention provide for filters adapted for preventing or reducing the formation of tarnish on an object containing a metal. The filter comprises an adsorbent to remove a tarnishing agent and a porous layer to hold and/or protect said adsorbent, wherein said adsorbent may be activated carbon, activated alumina, silica, silica gel, natural zeolite, synthetic zeolite, a molecular sieve, potassium permanganate, calcium carbonate, calcium sulfate, sodium carbonate, sodium hydroxide, calcium hydroxide, powdered metal, a reactant capable of scavenging gas phase contaminants, an ion exchange material, a catalytic agent and combinations thereof. The filter may also comprise a halide or a metal halide added to the adsorbent. The metal of said metal halide may be zinc, aluminum, magnesium, calcium, iron and combinations thereof. In one embodiment, the filter is adapted for use with a jewelry box, a silverware case, electronic equipment, or a computer. In another embodiment, the filter is adapted for use with an air circulation system.

Additional embodiments of the present invention provide for methods for inhibiting or preventing tarnish from forming on an object containing metal. In one embodiment, the method comprises providing an apparatus comprising an adsorbent and a device to circulate air through said adsorbent to remove an agent that causes the formation of tarnish on said object; and circulating the air through said apparatus to prevent or reduce the formation of tarnish on said object. Said adsorbent may be a physisorber, a chemisorber, an ion exchange material, a catalytic agent and combinations thereof. Said physisorber may be activated carbon, activated alumina, silica, silica gel, natural zeolite, synthetic zeolite, a molecular sieve and combinations thereof, and said chemisorber may be potassium permanganate, calcium carbonate, calcium sulfate, sodium carbonate, sodium hydroxide, calcium hydroxide, powdered metal, a reactant capable of scavenging gas phase contaminants and combinations thereof.

In another embodiment, said apparatus used in the method further comprises a first porous layer, wherein said adsorbent is adhered to or non-adheredly placed next to said first porous layer, whereby an adsorbent filter is created.

In another embodiment, said apparatus used in the method further comprises a second porous layer, wherein said adsorbent is configured between said first porous layer and said second porous layer.

In another embodiment, said apparatus used in the method further comprises an intake vent to allow air to flow into said apparatus, a pre-filter to remove a particulate contaminant from the air prior to allowing the air to flow through said adsorbent and an exhaust vent to allow air to flow out of said apparatus.

In another embodiment, said adsorbent filter further comprises a halide or a metal halide. The metal of said metal halide may be zinc, aluminum, magnesium, calcium, iron and combinations thereof.

Another embodiment of the present invention provides for an apparatus for preventing or reducing the formation of tarnish on an object containing a metal, comprising an adsorbent, a device to circulate air through said adsorbent to remove a tarnishing agent and a box to store said object.

Other features and advantages of the invention will become apparent from the following detailed description, taken in conjunction with the accompanying drawings, which illustrate, by way of example, various features of embodiments of the invention.

### BRIEF DESCRIPTION OF THE DRAWINGS

Exemplary embodiments are illustrated in the referenced figures. It is intended that the embodiments and figures disclosed herein are to be considered illustrative rather than restrictive.

FIG. 1 depicts a cross sectional portion of an adsorbent filter in accordance with an embodiment of the present invention.

FIG. 2 depicts an exemplary configuration of an apparatus for preventing or reducing the formation of tarnish in accordance with an embodiment of the present invention.

FIG. 3 depicts an exemplary configuration of an apparatus for preventing or reducing the formation of tarnish in accordance with an embodiment of the present invention.

FIG. 4 depicts an apparatus for preventing or reducing the formation of tarnish on objects that is integrated into a box capable of storing said objects in accordance with an embodiment of the present invention.

FIG. 5 depicts an apparatus for preventing or reducing the formation of tarnish on objects that is integrated into a box capable of storing said object in accordance with another embodiment of the present invention.

### DETAILED DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs.

One skilled in the art will recognize many methods and materials similar or equivalent to those described herein, which could be used in the practice of the present invention. Indeed, the present invention is in no way limited to the methods and materials described. For purposes of the present invention, the following term is defined below.

“Tarnishing agent” as used herein refers to an agent capable of reacting with a metal to corrode the metal. This reaction may be through, but is not limited to, an oxidative process. Examples of tarnishing agents include but are not limited to hydrogen sulfide, sulfur oxides, carbonyl sulfide, carbon disulfide, nitrogen oxides, ozone, halogen gases, ammonia, ammonium salts, and mixtures thereof. One skilled in the art will recognize other agents that are capable of reacting with a metal to corrode the metal.

The present invention uses adsorbents capable of removing tarnishing agents from the surrounding air. Adsorbents having high adsorptive capacity for tarnishing agents may be used to remove the tarnishing agents from the surrounding air. These adsorbents may be physisorbers (e.g., activated carbon, activated alumina, silica, silica gel, natural or synthetic zeolite, a molecular sieve), chemisorbers (e.g., potassium permanganate, calcium carbonate, calcium sulfate, sodium carbonate, sodium hydroxide, calcium hydroxide, powdered metal), ion exchange material, and catalytic agents (e.g., a catalytic filter). Reactants capable of scavenging gas phase contaminants may also be used with various embodiments of the present invention.

In general, the present invention provides an apparatus comprising an intake vent, followed by a woven pre-filter that serves to remove larger particulate contaminants in the atmosphere, an adsorbent filter and an exhaust vent. The apparatus also includes a device to circulate the air through the aforementioned components.

The pre-filter is intended to protect and prolong the life of the physisorbant and/or chemisorbant filter which may be comprised of physisorbers, chemisorbers, ion exchange materials, catalytic fillers, as well as mixtures of these materials. When the adsorptive capacity of the adsorbent filter has been exhausted, it may be removed from the apparatus, and a new filter cartridge may be inserted in the apparatus to provide continued protection of the objects.

In one embodiment, the apparatus may be placed in an enclosed space (e.g., a box, a room, a case, etc.) to remove tarnishing agents in the enclosed space and thus prevent or reduce the formation of tarnish on objects that are placed in the enclosed space. In various embodiments, the apparatus is adapted for use with a jewelry box, a silverware case, electronic equipment, a computer and the like.

In another embodiment, the apparatus may also be adapted for use with air circulation systems; for example, air condition systems, heating systems and the like. In such embodiments, the apparatus removes tarnishing agents from a room, a house, an apartment, an office building, a warehouse, an industrial building, a car and the like.

In another embodiment, the apparatus may be integrated into a box that can store the object.

Halides and/or metal halides may be added to the adsorbents. Examples of halides include, but are not limited to, chloride, fluoride, bromide and iodide. Metal halides are compounds between a metal and a halogen. Examples of metal halides include, but are not limited to aluminum chloride, barium chloride, cadmium chloride, cesium chloride, cesium fluoride, cesium iodide, calcium chloride, calcium fluoride, cerium(iii) chloride, chromium(iii) chloride, cobalt(ii) chloride, copper(i) chloride, copper(i) iodide, copper(ii) chloride, gold(iii) chloride, iron(ii) chloride, iron(iii) chloride, lead(ii) chloride, lead(ii) iodide, lithium chloride, magnesium chloride, magnesium fluoride, manganese(ii) chloride, manganese(iv) fluoride, mercury(i) chloride, mercury(ii) chloride, nickel(ii) chloride, plutonium fluoride, potassium chloride, potassium iodide, radium chloride, rhodium(iii) chloride, silver bromide, silver chloride, silver iodide, silver subfluoride, silver(i) fluoride, silver(i) selenide, sodium bromide, sodium chloride, sodium fluoride, sodium iodide, tin(ii) chloride, tin(iv) chloride, titanium tetrachloride, titanium tetraiodide, tungsten hexachloride, tungsten(vi) fluoride, uranium hexafluoride, uranium pentafluoride, uranium tetrafluoride, vanadium tetrachloride, zinc chloride, and zirconium(iv) chloride. Particularly useful metal halides include halides of the following metals: zinc, aluminum, magnesium, calcium and iron.

One embodiment of the present invention provides for a filter to remove a tarnishing agent from the air. As shown in FIG. 1, the filter may be made by placing the adsorbent 102 between two or more layers of porous material 101. The porous layer may serve to hold and/or protect said adsorbent. Alternatively, the adsorbent may be adhered to one or more layers of porous material. Halides and/or metal halides may be added to the adsorbents. The filter may be adapted for placement into a cartridge. The filter and/or the cartridge may be disposable. The filter may be adapted for use in conjunction with any apparatus for which the formation of tarnish on an object contained in the apparatus is sought to be reduced; for example, jewelry boxes, silverware cases, electronic equipment, electronic components, computer components, circuits and computers. In another embodiment, the filter may be adapted for use with air circulation systems; for example, air condition systems, heating systems and the like. In one embodiment, the filter may be adapted for use on an air vent. In such embodiments, the apparatus removes tarnishing agents from a room, a house, an apartment, an office building, a warehouse, an industrial building, a car and the like.

Another embodiment of the present invention provides for an apparatus for preventing or inhibiting the formation of tarnish on an object. The apparatus may be used, for example, in boxes that store jewelry, silverware, electronic components, circuits and computer components. The apparatus comprises an adsorbent and a device capable of circulating the enclosed air through the adsorbent. The adsorbent may be in the form of an adsorbent filter or an adsorbent filter cartridge as described above. The adsorbent filter or adsorbent filter cartridge may be removable and/or disposable. The apparatus may further comprise an intake vent, a pre-filter and an exhaust vent. The pre-filter is useful for removing particulate contaminants in the surrounding air; for example, dust. The pre-filter may help protect and prolong the functionality of the adsorbent. The device capable of circulating air through the adsorbent may be a fan. The fan may be powered by electricity; for example, via an electric outlet or by battery. Those of skill in the art will recognize many other systems that can provide power to the fan. This invention provides protection against atmospheric tarnishing agents in an enclosed space for valuable objects such as jewelry, silverware, coins, brass and copper vessels, and the like. The amount of time that the articles would be protected from tarnishing depends on a number of variables, for example, the concentration of tarnishing agents in the environment (e.g., home, office, restaurant, museum, industrial setting, etc.), relative humidity, and the amount of time during which the enclosing case or space in which the apparatus is placed or used remains open. Additionally, the degree of tarnish would also depend on the constant availability of power to the apparatus; the amount of time during which the articles are outside of the enclosed space; and the atmosphere to which these articles are exposed.

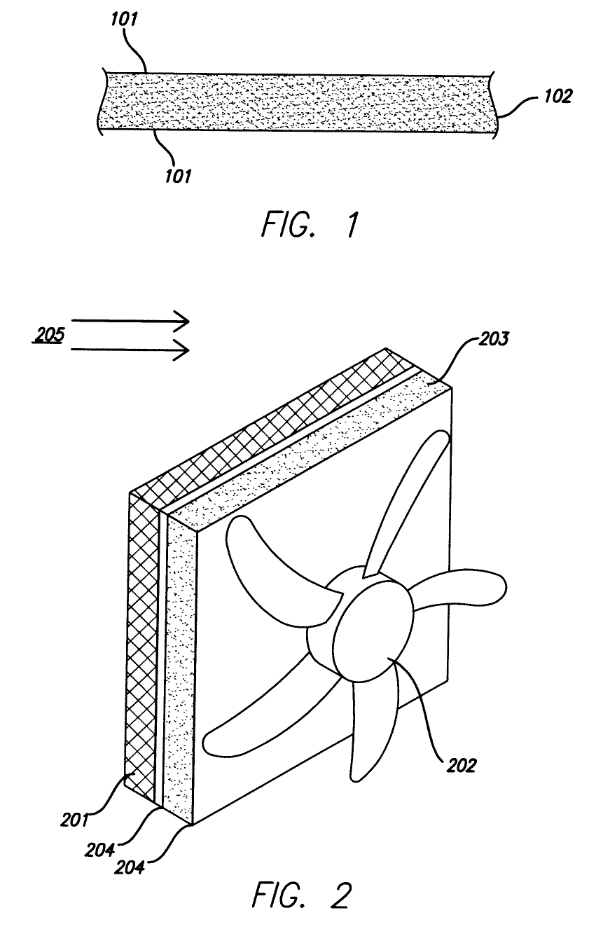

FIG. 2 depicts an exemplary configuration of an apparatus for preventing or reducing the formation of tarnish on an object. The apparatus comprises a pre-filter 201, a fan 202, and adsorbent 203 between two porous layers 204. The direction of the airflow 205 is first through the pre-filter and then through the adsorbent (contained between porous layers). In embodiments where a pre-filter is used, one of skill in the art will understand that the position of the pre-filter 201, the fan 202 and the adsorbent filter 203 may be placed in any order such that the direction of the airflow is through the pre-filter 201 prior to going through the adsorbent filter 203 as this provides protection to the adsorbent filter 203.

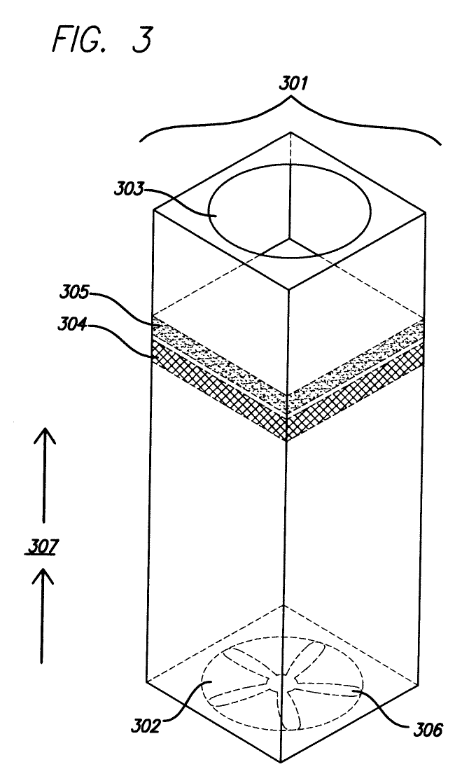

FIG. 3 depicts an apparatus for preventing or reducing the formation of tarnish on an object in accordance with another embodiment of the invention. A box 301 comprises an inlet vent 302, an exhaust vent 303, a pre-filter 304, an adsorbent filter 305 and a fan 306. The direction of the airflow 307 is through the inlet vent 302, then through the pre-filter 304, then through the adsorbent filter 305 and out through the exhaust vent 303.

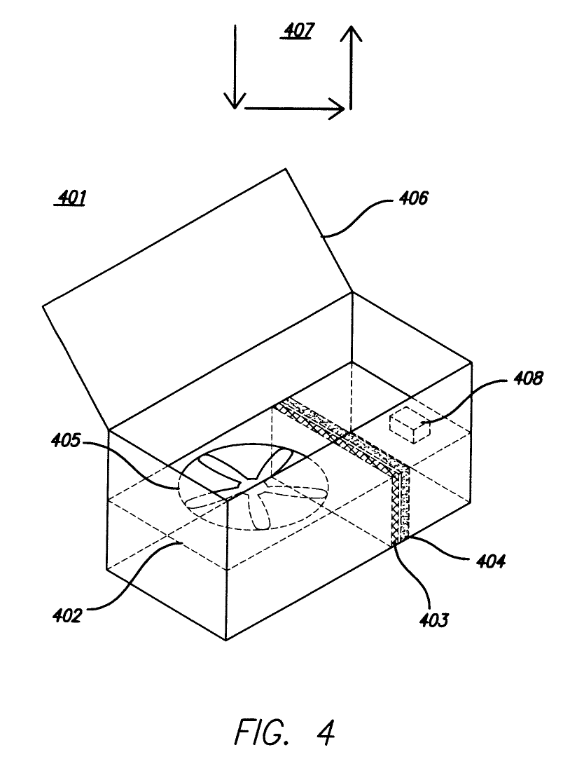

In another embodiment, the apparatus is integrated into a box that can store objects that may become tarnished. A particular embodiment is depicted in FIG. 4. A box 401 with a lid 406 is configured to hold a permeable layer 402. An object 408 may be placed on top of the permeable layer 402, although the object 408 itself is not a component of the apparatus. Below the permeable layer 402 is a pre-filter 403 and an adsorbent filter 404 which separates the bottom portion of the box 401. On one side of the bottom portion of the box 401, a fan 405 is placed in a position which allows it to draw the air downwards. The direction of airflow 407 is drawn through the fan 405, then through the pre-filter 403, then through the adsorbent filter 404 and then back up through a portion of the permeable layer 402 where it can again circulate through the components. The permeable layer 402 may be rigid and capable of supporting objects by itself, or it may be pliant and placed under, over, or between a support structure, or combinations thereof. The pre-filter 403 and the adsorbent filter 404 may be removable and/or disposable. The fan 405 may be placed below the permeable layer 402.

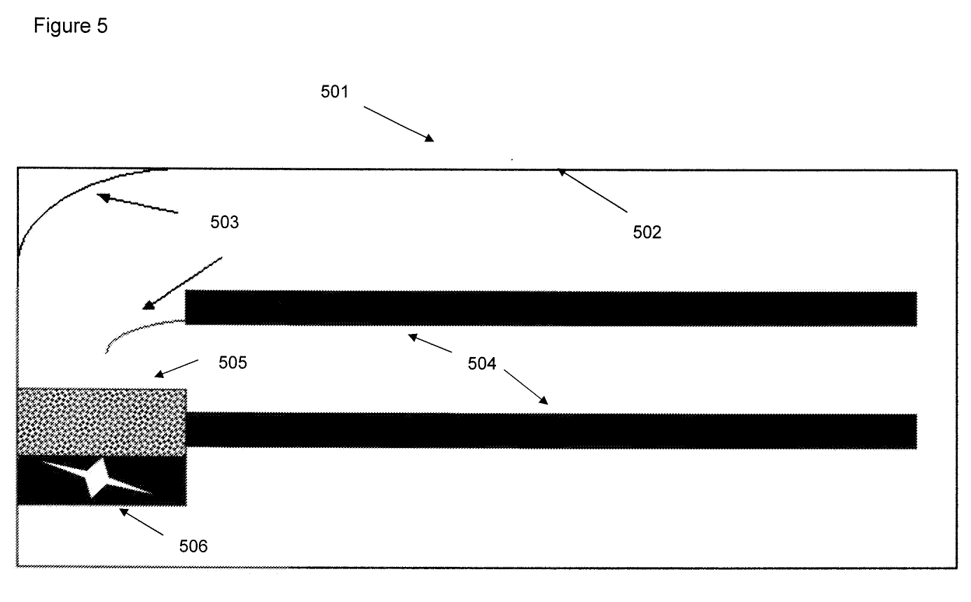

Another embodiment wherein the apparatus is integrated into a box that can store objects that may become tarnished is depicted in FIG. 5. A box 501, with a lid 502 is configured to hold one or more removable trays 504. The lid 502 may be a hinged lid. The box 501 may further comprise air guides 503 to guide the air that circulates in the box. A fan 506 circulates the air through the adsorbent filter 505.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. An apparatus for preventing or reducing the formation of tarnish on an object containing a metal, comprising:
an adsorbent; and
a device to circulate air through said adsorbent to remove an agent that causes the formation of tarnish on said object.

2. The apparatus of claim 1, further comprising a first porous layer,
wherein said adsorbent is adhered to or non-adheredly placed next to said first porous layer, whereby an adsorbent filter is created.

3. The apparatus of claim 2, further comprising a second porous layer,
wherein said adsorbent is configured between said first porous layer and said second porous layer.

4. The apparatus of claim 1, further comprising:
an intake vent to allow air to flow into said apparatus;
a pre-filter to remove a particulate contaminant from the air prior to allowing the air to flow through said adsorbent; and
an exhaust vent to allow air to flow out of said apparatus.

5. The apparatus of claim 1, further comprising a removable filter cartridge that encases said adsorbent.

6. The apparatus of claim 1, wherein said adsorbent is selected from the group consisting of a physisorber, a chemisorber, an ion exchange material, a catalytic agent and combinations thereof.

7. The apparatus of claim 6, wherein said physisorber is selected from the group consisting of activated carbon, activated alumina, silica, silica gel, natural zeolite, synthetic zeolite, a molecular sieve and combinations thereof, and said chemisorber is selected from the group consisting of potassium permanganate, calcium carbonate, calcium sulfate, sodium carbonate, sodium hydroxide, calcium hydroxide, powdered metal, a reactant capable of scavenging gas phase contaminants and combinations thereof.

8. The apparatus of claim 2, wherein said adsorbent filter further comprises a halide or a metal halide.

9. The apparatus of claim 8, wherein the metal of said metal halide is selected from the group consisting of zinc, aluminum, magnesium, calcium, iron and combinations thereof.

10. The apparatus of claim 1, wherein said apparatus is adapted for use with a jewelry box, a silverware case, electronic equipment, or a computer.

11. The apparatus of claim 1, wherein said apparatus is adapted for use with an air circulation system.

12. A filter adapted for preventing or reducing the formation of tarnish on an object containing a metal, comprising:
an adsorbent to remove a tarnishing agent; and
a porous layer to hold and/or protect said adsorbent,
wherein said adsorbent is selected from the group consisting of activated carbon, activated alumina, silica, silica gel, natural zeolite, synthetic zeolite, a molecular sieve, potassium permanganate, calcium carbonate, calcium sulfate, sodium carbonate, sodium hydroxide, calcium hydroxide, powdered metal, a reactant capable of scavenging gas phase contaminants, an ion exchange material, a catalytic agent and combinations thereof.

13. The filter of claim 12, further comprising a halide or a metal halide added to said adsorbent.

14. The filter of claim 13, wherein the metal of said metal halide is selected from the group consisting of zinc, aluminum, magnesium, calcium, iron and combinations thereof.

15. The filter of claim 12, wherein said filter is adapted for use with a jewelry box, a silverware case, electronic equipment, or a computer.

16. The filter of claim 12, wherein said filter is adapted for use with an air circulation system.

17. A method for inhibiting or preventing tarnish from forming on an object containing metal, comprising:
providing an apparatus comprising:
an adsorbent; and
a device to circulate air through said adsorbent to remove an agent that causes the formation of tarnish on said object; and
circulating the air through said apparatus to prevent or reduce the formation of tarnish on said object.

18. The method of claim 17, wherein said apparatus further comprises a first porous layer,
wherein said adsorbent is adhered to or non-adheredly placed next to said first porous layer, whereby an adsorbent filter is created.

19. The method of claim 18, wherein said apparatus further comprises a second porous layer,
wherein said adsorbent is configured between said first porous layer and said second porous layer.

20. The method of claim 17, wherein said apparatus further comprises:
an intake vent to allow air to flow into said apparatus;
a pre-filter to remove a particulate contaminant from the air prior to allowing the air to flow through said adsorbent; and
an exhaust vent to allow air to flow out of said apparatus.

21. The method of claim 17, wherein said adsorbent is selected from the group consisting of a physisorber, a chemisorber, an ion exchange material, a catalytic agent and combinations thereof.

22. The method of claim 21, wherein said physisorber is selected from the group consisting of activated carbon, activated alumina, silica, silica gel, natural zeolite, synthetic zeolite, a molecular sieve and combinations thereof, and said chemisorber is selected from the group consisting of potassium permanganate, calcium carbonate, calcium sulfate, sodium carbonate, sodium hydroxide, calcium hydroxide, powdered metal, a reactant capable of scavenging gas phase contaminants and combinations thereof.

23. The method of claim 18, wherein said adsorbent filter further comprises a halide or a metal halide.

24. The method of claim 23, wherein the metal of said metal halide is selected from the group consisting of zinc, aluminum, magnesium, calcium, iron and combinations thereof.

25. An apparatus for preventing or reducing the formation of tarnish on an object containing a metal, comprising:
an adsorbent;
a device to circulate air through said adsorbent to remove a tarnishing agent; and
a box to store said object,
wherein said adsorbent and said device are integrated into said box.
